(19) United States
(12) Patent Application Publication
(10) Pub. No.: US 2014/0271981 A1
(43) Pub. Date: Sep. 18, 2014

(54) Prebiotic Compositions And Method Of Its Use

(71) Applicant: Making People Better, LLC, Springfield, MO (US)

(72) Inventor: Kerri Miller, Springfield, MO (US)

(73) Assignee: Making People Better, LLC, Springfield, MO (US)

(21) Appl. No.: 14/210,229

(22) Filed: Mar. 13, 2014

Related U.S. Application Data
(60) Provisional application No. 61/780,939, filed on Mar. 13, 2013.

(51) Int. Cl. A23L 1/30

(52) U.S. Cl. CPC A23L 1/3002
USPC 426/2; 426/71

(57) ABSTRACT

A composition suitable for rehydration or as a prebiotic supplement is disclosed. The composition may contain Agave fructan and ginger root extract, among other ingredients. The composition is beneficial to the probiotic bacteria of an individual, and may also help improve the health of the individual.

### RELATED APPLICATION

This application claims priority to U.S. Patent application 61/780,939 filed Mar. 13, 2013, the entire content of which is hereby incorporated by reference into this application.

### FIELD OF THE INVENTION

This disclosure pertains to a composition for improving health in an individual. More particularly, it relates to combination of several components in making a composition that possesses rehydration as well as prebiotic functionalities.

### DESCRIPTION OF RELATED ART

Water is essential for human body. It has been estimated that human bodies are made up of 55-75% water. The majority of the water is found inside the cells (intracellular) with the remaining being found outside the cell wall (extracellular).

Hydration is the addition of a water-based fluid in order to restore and maintain fluid balance in the body. Dehydration is a condition that occurs when the amount of fluid (e.g., water) loss from the body exceeds the amount that is taken in by the body. When the body loses too much water, normal metabolism may be disrupted. Dehydration may cause dizziness, fainting, among other symptoms. In the most severe cases, dehydration may lead to death. Dehydration may be caused by infectious diarrhea, by vomiting, by excessive sweating during exercise, or by other physiological or environmental conditions.

Administration of a rehydration solution may help prevent dehydration and electrolyte imbalances. By way of example, some oral rehydration therapy involves the administration of a rehydration solution containing glucose and sodium in water. Absorption of the sodium ion in the intestines may lead to absorption of water molecules associated with the sodium ion. Because glucose can activate sodium absorption, glucose has been used in some rehydration formulations along with sodium. Oral rehydration therapy may be used to treat acute dehydration. It may also be used to maintain a healthy level of hydration in the body.

One example of a rehydration solution is an aqueous liquid containing from 35 to 90 milliequivalents per Liter (meq/L) of sodium (Na⁺) and from 1.2 to 3.0 weight percent (wt %) of a glucose containing saccharide. A rehydration solution may have a total osmolarity of from about 200 to about 311 meq/L. The glucose-containing saccharide may be glucose (i.e. dextrose), or a saccharide that can be hydrolyzed to form a composition containing glucose. Certain rehydration solutions also contain potassium, chloride, citrate and/or bicarbonate.

Despite efforts in developing effective measures to prevent dehydration related illness or death, management of acute dehydration remains a challenge. Acute dehydration usually results from massive loss of water due to conditions such as diarrhea or vomiting, among others. One of the main causes of diarrhea is through infection by Clostridium difficile (C. difficile). Infection with C. difficile manifests itself clinically as uncomplicated diarrhea or nonspecific colitis, and the most severe form of manifestation is pseudomembranous colitis (PMC). Death may occur from complications such as dehydration, toxic megacolon or intestinal perforation.

No antibiotics have proven to be highly effective in preventing/treating C. difficile associated diseases. In fact, under certain circumstances, antibiotics cause more harm than good because the antibiotics may wipe out the indigenous microflora in the gastrointestinal (GI) system of the host.

### SUMMARY

The instrumentalities disclosed herein advance the art and overcome the problems outlined above by providing compositions and methods for rehydrating an individual. In addition to its rehydration function, the disclosed composition may also help improve the well beings of the indigenous microflora. Moreover, the ginger extract in the composition may inhibit vomiting thereby alleviating water loss.

In one embodiment, a composition is disclosed which contains at least the following three components: (a) agave fructan, and (b) a ginger root extract. In another embodiment, a composition is disclosed which contains at least the following four components: (a) potassium, (b) agave fructan, (c) sodium, and (d) a ginger root extract.

In another embodiment, a hydration formula is disclosed which contains electrolytes, sodium, potassium, chloride, and citrate as well as other immune and gut supporting ingredients such as zinc, ginger root, inulin fiber, L-glutamine, and the probiotic Bacillus coagulans BC30. These ingredients may help support the body during rehydration and may support the gastrointestinal tract for proper nutrient absorption.

In another embodiment, a method is disclosed for rehydrating an individual. In one aspect, the disclosed composition and method may be used for rehydrating an individual in need of rehydration. Various clinical indicators of an individual may be assessed to determine if such an individual is in need of rehydration. The rate of administration and the quantity of the rehydration solution to be used for each administration may also be determined based on such assessment. In another aspect, the disclosed composition may be used by oral administration to the individual.

In another embodiment, the disclosed method may include administering a composition to an individual, wherein the composition contains (a) fructan, and (b) a ginger root extract. In another embodiment, the composition further contains sodium and potassium. Examples of sodium may include but are not limited to sodium citrate, sodium chloride, among others. Examples of potassium may include but are not limited to potassium citrate, potassium chloride, among others.

The fructans are polymers of fructose generally linked to a moiety of a terminal glucose. In one embodiment, the fructan is a fructan that is derived from a plant. In one aspect, the plant may be selected from the group consisting of the Agave genus, the Dasylirion genus, Chicory, Camas, Dandelion, Elecampane, Artichoke, Onion, Asparagus, Wheat, Garlic, Oat, Banana, and combination thereof. See e.g., Lopez M. et al., “Agave fructans as prebiotics” 1-14, in Recent Advances in Fructooligosaccharides Research (2007), ed. Norio et al.; see also, Gomez et al., Journal of Applied Microbiology, 108: 2114-2121 (2010). In another aspect, the fructan is one or more fructans or mixtures thereof that are the same as those found in the Agave genus or the Dasylirion genus of plants. In another aspect, the fructan is isolated from the Agave genus or the Dasylirion genus of plants. In another aspect, the fructan of the disclosed composition contains both β-(2-1) and β-(2-6) linkages, or in other words, they contain both (2-1) and (2-6) linked β-D-fructosyl units.

In one embodiment, the indigestible oligosaccharide and the fructans are resistant to hydrolysis by human digestive enzymes. As a result these products pass undigested through the upper part of the gastrointestinal tract into the colon, where they may be utilized as a substrate for the endogenous bacteria. In one aspect, the frauctans may be present in the disclosed composition in an amount effective to enhance probiotic bacteria in the digestive system of an individual when the composition is administered to the individual.

The ginger extract present in the composition may help reduce nausea or vomiting. In one aspect, the ginger extract may be present in the composition in an amount effective to reduce nausea or vomiting when the composition is administered to an individual.

In one embodiment, the disclosed composition may be in the form of a solid, such as, for example, powder or other forms of dry or semi-dry mixture. In one aspect, the indigestible oligosaccharide may be present in the composition in an amount of from 0.1% to 5% (w/w), 0.2% to 4% (w/w), or from 0.5% to 2% (w/w). In another aspect, the ginger extract may be present in the composition in an amount of from 0.05% to 5% (w/w), 0.1% to 3% (w/w), 0.1% to 2% (w/w), 0.2% to 1% (w/w), or 0.2% to 0.3% (w/w) The ginger extract to be used may be a pure ginger root extract, or it may be in a form of a powder containing ginger root extract along with other ingredients. By way of example, a 4:1 ginger root extract contains 25% (by weight) ginger root. In another aspect, the Agave fructan may be present in the composition in an amount of from 0.05% to 10% (w/w), 0.1% to 10% (w/w), 1% to 6% (w/w), or 5% to 6% (w/w).

In another embodiment, the disclosed composition may be in the form of a liquid. Examples of liquid may include but are not limited to a concentrated solution, a dilute solution, or a liquid suspension. In another aspect, a liquid form of the disclosed composition may be reconstituted from a solid form by the addition of water, or a buffered solution. In another aspect, the reconstituted solution may be filtered to remove insolubles, if any. In another aspect, the ginger root extract may be present in the composition in an amount of from 0.05 to 5 grams per liter, from 0.05 to 1 gram per liter, or from 0.05 to 0.5 gram per liter. In another aspect, the Agave fructan may be present in the composition in an amount of from 0.05 to 10 grams per liter, from 0.1 to 2 grams per liter, or from 1 to 10 grams per liter.

In another embodiment, the composition may also contain one or more ingredients selected from the group consisting of flavorants, colorants, preservatives, excipients, gelling agents, rice derivatives, amino acids, zinc, calcium, vitamins, and dietary supplements. In one aspect, the composition may contain an amino acid, glutamine. The glutamine may be present in the composition in an amount of from 10% to 60% (w/w) from 20% to 60% (w/w), or from 20% to 40% (w/w).

In another embodiment, the composition may be a solid composition that may be reconstituted in making a rehydration solution. Water may be used for the reconstitution. Alternatively, a solution may be used for the reconstitution. The solid composition may contain from 3% to 5% (w/w) of sodium, from 1% to 3% (w/w) of potassium, from 30% to 40% (w/w) of L-glutamine, from 0.5% to 1% (w/w) of Agave fructan, and from 1% to 2% (w/w) of a ginger root extract.

In another embodiment, a liquid composition suitable for rehydration is disclosed, wherein the composition may contain per liter from 1.5 to 2 grams of sodium, from 0.5 to 1 gram of potassium, from 15 to 20 grams of L-glutamine, from 0.2 to 1 gram of Agave fructan, and from 0.2 to 1 gram of a ginger root extract. In another embodiment, the disclosed composition may also contain one or more flavorants in an amount of from 20% to 40% (w/w). In another embodiment, the disclosed composition may also contain zinc in an amount of from 0.01% to 0.2% (w/w). In another embodiment, the disclosed composition may also contain one or more probiotic bacteria in an amount 0.1 to 10 billion colony forming unit (CFU) per 100 grams of the composition.

### DETAILED DESCRIPTION

The present disclosure relates to compositions and methods for rehydration and for enhancing the well beings of probiotic organisms. The disclosed compositions may also help reduce nausea and/or vomiting.

In one embodiment, an optimal hydration formula may include some or all of the following components: electrolytes, sodium, potassium, chloride, and citrate as well as other immune and gut supporting ingredients such as zinc, ginger root, inulin fiber, L-glutamine, and the probiotic Bacillus coagulans BC30.

Electrolytes are substances which dissociate into cations and anions in aqueous solutions. Normal plasma concentration of sodium (Na⁺) is 132-152 mmol/L, potassium (K⁺) is 3.5-5.5 mmol/L, chloride (CY) is 90-110 mmol/L, with a pH of 7.4. The intracellular concentrations are 10, 155, and 8 mmol/L respectively with a pH of 7.4 as well.

Inulin fiber may help improve the well being of the good bacteria in the gut. The normal bacteria found throughout the intestine play a significant role in overall health. During an episode of acute illness, the protective mucous membrane lining the intestinal tract is disrupted causing a state of imbalance. Prebiotics differ from probiotics (good bacteria) in that they are not a live organism but are a non-digestible carbohydrate and thus food for the probiotics. Once ingested they almost completely bypass the upper digestive system and reach the intestine intact where they begin fermentation by the normal gut microbiota. The fermentation process stimulates and promotes the production of “good bacteria” such as Bifidobacteria and Lactobacilli. This process allows the recovery of a healthy microflora and improves overall immunity.

Glutamine is one of the most abundant naturally occurring amino acids in the body. It is classified as a non-essential amino acid but play important roles in the body.

Zinc is one of the most important micronutrients in the body Zinc is essential for human growth and development and serves as a key co-factor of the immune system. It is needed for proper T-cell and natural killer (NK) cell function as well as for proper lymphocyte activity.

Ginger is an ancient Chinese medicinal root plant that has been used to treat a myriad of conditions. One of the most common uses for ginger root is treatment of nausea and vomiting. Ginger root may reduce nausea and vomiting, motion sickness, and pregnancy induced morning sickness. The ginger root in the disclosed composition may add natural flavor and help decrease nausea and vomiting.

Fortifying with healthy probiotics supports and promotes digestive health and supports a healthy immune system. The function of probiotics include proteolysis (breakdown of protein), lipolysis (breakdown of fat), and the ultimate conversion of carbohydrates (including lactose) into lactic acid. As they travel into the gastrointestinal tract, probiotics produce metabolites beneficial in suppressing putrefactive microorganisms. These metabolites include end-products such as lactic acid and bacteriocins. The metabolic activity of these beneficial gut bacteria enzymes also help in the further digestion of food components, improve bioavailability of minerals and other nutrients, produce short-chain fatty acids, polyamines, vitamins (such as Vitamins B and K), antioxidants, etc.

By way of example, one of these lactic acid producing bacteria and probiotic is Bacillus coagulans BC30. Bacillus coagulans is unique as compared to other probiotics in that it is surrounded by a naturally, spore-like, and protective coating, which allows the bacteria to survive the harsh acidic environment of the stomach as well as the bile acid further down the intestine. Traditional lactic acid bacteria do not survive in large quantities in the stomach and must be supplied in large dosages in order to reach the intestine intact. After oral supplementation the Bacillus coagulans spores arrive in the stomach, where they are exposed to the acidic and churning environment, allowing the protective coating to be hydrated, followed by swelling and thus the germination process begins.

In another embodiment, the disclosed composition may be prepared as an isotonic/hypotonic oral rehydration solution. In one aspect, the optimal rehydration formula may have an osmolality of about 280 mOsm/L, or in the range of 200 mOsm/L to 350 mOsm/L, making it as effective as IV hydration. The concept of osmolality is sometimes overlooked. In another embodiment, to allow for the most rapid rehydration, a rehydration solution may be maintained as hypotonic and have an osmolality of <280 mOsm/L.

The term “prebiotics” refer to compositions or ingredients that stimulate the growth and/or activity of beneficial microbial strains residing in a host's GI system. These beneficial microorganisms are also called probiotic organisms or probiotics. Many of the probiotic bacteria are capable of producing lactic acid. The most common types of beneficial microorganisms are the genera of Lactobacillus and Bifidobacterium. See e.g., Duggan et al., Am. J. Clini Nutrition, 75(5): 789-808 (2002); see also, Venter, C., Journal of Family Ecology and Consumer Sciences, Vol. 35, 17-25 (2007); and Bartolomeo et al., Phytotherapy Research (2012).

The disclosed method may include administering a composition to an individual, wherein the composition contains (a) Agave fructan, and (b) a ginger root extract. The composition may further contain sodium. Fructans are polymers of fructose residues typically built up with a sucrose unit (i.e. a glucose-fructose disaccharide). The linkage position of the fructose residues determine the type of the fructan. Linkage normally occurs at one of the two primary hydroxyls, namely, OH-1 or OH-6. Fructans from Agave and Dasylirion contain a complex mixture of fructans and are highly branched. They contain principally β(2-1) linkages as well as some β(2-6) linkages. The fructan may be also referred to as inulin, and may be obtained from many plant sources, which include but are not limited to the Agave genus, the Dasylirion genus, Chicory, Camas, Dandelion, Elecampane, Artichoke, Onion, Asparagus, Wheat, Garlic, Oat, and Banana.

For purpose of this disclosure, the term “in an amount effective” means the lowest amount that is sufficient to achieve the stated effect to a level that is significant as compared to a subject who has not been administered the composition.

The terms “ingredient,” “component,” and “constituent” may be used interchangeably in this disclosure.

The compositions of the present disclosure may contain one or more other ingredients. It is to be understood that such additional ingredients may confer upon the disclosed compositions certain desirable properties. Examples of such desirable properties may include but are not limited to enhanced protection of beneficial microorganisms, increased stability of the composition and so on.

It is to be noted that, as used in this disclosure, the singular forms “a,” “an,” and “the” include plural referents unless the context clearly dictates otherwise. Thus, for example, reference to “a composition” includes reference to two or more of such compositions. The terms “from,” “to,” between” are meant to be inclusive in this disclosure. For instance, the phrase “an integer between 2 and 4” refers to the number 2, 3, or 4.

The disclosed compositions may be prepared and/or distributed in a solid form, a concentrated liquid form or a diluted liquid form. A concentrate may be dissolved or dispersed in a solvent to form a reconstituted solution.

The following examples illustrate the present disclosure. These examples are provided for purposes of illustration only and are not intended to be limiting. The chemicals and other ingredients are presented as typical components or reactants, and various modifications may be derived in view of the foregoing disclosure within the scope of the invention.

### EXAMPLE 1

### A Rehydration Composition—Formula One

For purpose of illustration, a composition was prepared according to the formula as shown in Table 1. The total amount of the premix as shown in Table 1 was 38.45 grams, which was suitable for making one liter of oral rehydration solution. The shelf life of the composition was at least 24 months under proper storage conditions.

TABLE 1
Composition for an oral rehydration solution (total 38.45 grams)

| | Amount |
|---|---|
| Ingredients | (gram) |
| Agave Fructan | 0.35 |
| Chloride (as potassium chloride, USP) | 0.713 |
| Citrate (as Sodium Citrate, USP-FCC) | 1.577 |
| Potassium (as potassium chloride, USP- | 0.75 |
| FCC) | |
| potassium chloride (USP-FCC) | 1.5 |
| Sodium (as Sodium chloride, USP) | 1.022 |
| Sodium (as Sodium citrate, USP-FCC) | 0.68 |
| Sodium chloride (USP) | 2.6 |
| Sodium citrate (2H₂O) (USP-FCC) | 2.9 |
| Zinc (as Zinc sulfate, USP-FCC) | 0.37 |
| L-Glutamine (USP-FCC) | 16.0754 |
| Ginger Root Extract | 0.5 |

### EXAMPLE 2

### A Rehydration Composition—Formula Two

For purpose of illustration, a composition was prepared according to the formula as shown in Table 2.

TABLE 2
Composition for an oral rehydration mix (Formula two)

| Ingredients | % by weight |
|---|---|
| Agave Fructan | 5.81 |
| Potassium chloride | 3.18 |
| Potassium citrate | 0.35 |
| Sodium chloride | 8.89 |
| Sodium citrate | 7.13 |
| Dipotassium phosphate | 1.26 |
| Zinc gluconate | 0.45 |
| L-Glutamine | 32.25 |
| Ginger Root 6:1 Powder | 1.45 |
| Probiotic (15 billion CFU per gram) | 0.19 |
| Citric Acid | 11.63 |
| Stevia Extract 97% (Rebaudioside) | 0.81 |
| Monk Fruit extract | 0.12 |
| Beet Root Powder | 0.29 |
| MET 4697 Lemonade Flavor natural | 20.35 |
| MET 4369 Raspberry Flavor | 5.81 |

Changes may be made in the compositions and methods without departing from the scope hereof. It should thus be noted that the matter contained in the above description should be interpreted as illustrative and not in a limiting sense. The following claims are intended to cover all generic and specific features described herein, as well as all statements of the scope of the present methods and compositions, which, as a matter of language, might be said to fall therebetween.

The contents of all cited references (including literature references, patents, patent applications, and websites) that are cited in this disclosure are hereby expressly incorporated by reference in their entirety for any purpose, as are the references cited therein.

We claim:

1. A composition comprising:
(a) a fructan derived from a plant selected from the group consisting of the Agave genus, the Dasylirion genus, Chicory, Camas, Dandelion, Elecampane, Artichoke, Onion, Asparagus, Wheat, Garlic, Oat, Banana, and combination thereof; and
(b) a ginger root extract.

2. The composition of claim 1, wherein the composition is in the form of a solid.

3. The composition of claim 1 further comprising sodium.

4. The composition of claim 2, wherein said fructan is an Agave fructan derived from a plant of the Agave genus.

5. The composition of claim 2, wherein said ginger root extract is present in the composition in an amount effective to reduce nausea or vomiting when the composition is administered to an individual.

6. The composition of claim 5, wherein said effective amount of said ginger root extract present in said composition is from 0.1% to 2% (w/w).

7. The composition of claim 6, wherein said ginger root extract is present in said composition in an amount from 0.2% to 0.3% (w/w).

8. The composition of claim 4, wherein the Agave fructan is present in the composition in an amount effective to enhance probiotic bacteria in the digestive system of an individual when the composition is administered to the individual.

9. The composition of claim 8, wherein said effective amount of said Agave fructan present in said composition is from 0.1% to 10% (w/w).

10. The composition of claim 9, wherein said Agave fructan is present in said composition in an amount of from 5% to 6% (w/w).

11. The composition of claim 2, further comprising at least one ingredient selected from the group consisting of flavorants, colorants, preservatives, excipients, gelling agents, rice derivatives, amino acids, zinc, calcium, vitamins, and dietary supplements.

12. The composition of claim 11, wherein the composition further comprises an amino acid glutamine, said glutamine being present in the composition in an amount of from 20% to 60% (w/w).

13. The composition of claim 1, wherein the composition is in the form of a liquid.

14. The composition of claim 13, wherein the ginger extract is present in the composition in an amount of from 0.1 to 2 grams per liter.

15. The composition of claim 13, wherein the fructan is present in the composition in an amount of from 0.1 to 2 grams per liter.

16. A solid composition suitable for making a rehydration solution, the composition comprising
(a) from 4% to 8% (w/w) of sodium;
(b) from 1% to 3% (w/w) of potassium;
(c) from 30% to 40% (w/w) of L-glutamine;
(d) from 2% to 8% (w/w) of Agave fructan; and
(e) from 0.1% to 0.4% (w/w) of a ginger root extract.

17. The solid composition of claim 16, the composition comprising
(a) from 6% to 7% (w/w) of sodium;
(b) from 1.5% to 2% (w/w) of potassium;
(c) from 30% to 40% (w/w) of L-glutamine;
(d) from 5.5% to 6% (w/w) of Agave fructan; and
(e) from 0.2% to 0.3% (w/w) of a ginger root extract.

18. The solid composition of claim 17, further comprising:
(f) one or more flavorants in an amount of from 20% to 40% (w/w);
(g) zinc in an amount of from 0.01% to 0.2% (w/w); and
(h) a probiotic bacterium in an amount 0.1 to 10 billion colony forming unit (CFU) per 100 grams of said composition.

19. A liquid composition suitable for rehydration, wherein the composition comprises per liter:
(a) from 1.5 to 3 grams of sodium;
(b) from 0.5 to 1 gram of potassium;
(c) from 15 to 20 grams of L-glutamine;
(d) from 1 to 10 grams of Agave fructan; and
(e) from 0.05 to 0.5 gram of a ginger root extract.

20. A method of rehydrating an individual, the method comprising administering a composition to said individual, wherein the composition comprises
(a) a fructan derived from a plant selected from the group consisting of the Agave genus, the Dasylirion genus, Chicory, Camas, Dandelion, Elecampane, Artichoke, Onion, Asparagus, Wheat, Garlic, Oat, Banana, and combination thereof; and
(b) a ginger root extract.

21. The method of claim 20 wherein the composition further comprises sodium.

22. The method of claim 20, wherein the composition is in the form of a liquid.

23. The method of claim 22, wherein said fructan is Agave fructan, and the Agave fructan is present in the composition in an amount of from 1 to 10 grams per liter.

24. The method of claim 22, wherein said ginger root extract is present in the composition in an amount of from 0.05 to 0.5 grams per liter.
